(19) United States
(12) Patent Application Publication
(10) Pub. No.: US 2020/0076205 A1
(43) Pub. Date: Mar. 5, 2020

(54) BATTERY MANAGEMENT SYSTEM, BATTERY, AND UNMANNED AERIAL VEHICLE

(71) Applicant: SZ DJI TECHNOLOGY CO., LTD., Shenzhen (CN)

(72) Inventors: Hao LUO, Shenzhen (CN); Dayang ZHENG, Shenzhen (CN)

(21) Appl. No.: 16/677,046

(22) Filed: Nov. 7, 2019

Related U.S. Application Data
(63) Continuation of application No. PCT/CN2017/083786, filed on May 10, 2017.

(51) Int. Cl. H02J 7/00; B64C 39/02; H01M 10/44; H01M 10/48

(52) U.S. Cl. CPC H02J 7/0014; B64C 39/024; B64C 2201/042; H01M 10/48; H02J 7/0026; H01M 10/44

(57) ABSTRACT

A battery includes a battery cell and a battery management system including a first interface configured to charge and discharge the cell, a second interface configured to charge the cell, and a controller communicatively coupled to the first and second interfaces. One end of the first interface is configured to be coupled to an external power supply or a UAV, and another end of the first interface is coupled to the cell. One end of the second interface is configured to be coupled to the external power supply, and another end of the second interface is coupled to the cell. The controller is configured to, when the first and second interfaces are electrically coupled to the UAV and the external power supply, respectively, control a circuit between the first interface and the cell and a circuit between the second interface and the cell to be closed.

### CROSS-REFERENCE TO RELATED APPLICATION

This application is a continuation of International Application No. PCT/CN2017/083786, filed on May 10, 2017, the entire content of which is incorporated herein by reference.

### TECHNICAL FIELD

The present disclosure relates to the field of unmanned vehicle and, more particularly, to a battery management system, a battery, and a UAV.

### BACKGROUND

Currently, an unmanned aerial vehicle (UAV) obtains electrical energy from a battery carried by the UAV, such that the UAV can be powered on and operated. However, the battery on the UAV generally has limited storage capacity and only provides electrical energy that supports 20 to 30 minutes of operation of the UAV. Currently, the battery has only one charge and discharge port. When the battery is low, the battery needs to be detached from the UAV, and then charged via the charge and discharge port. Since the battery is detached from the UAV, the UAV cannot be powered during a charging process of the battery, thereby causing the UAV to be inoperable.

### SUMMARY

In accordance with the disclosure, there is provided a battery including a battery cell and a battery management system configured to control charging and discharging of the battery cell. The battery management system includes a first interface configured to charge and discharge the battery cell, a second interface configured to charge the battery cell, and a controller communicatively coupled to the first interface and the second interface. One end of the first interface is configured to be coupled to an external power supply or an unmanned aerial vehicle (UAV), and another end of the first interface is coupled to the battery cell. One end of the second interface is configured to be coupled to the external power supply, and another end of the second interface is coupled to the battery cell. The controller is configured to, in response to detecting that the first interface is electrically coupled to the UAV and the second interface is electrically coupled to the external power supply, control a circuit between the first interface and the battery to be closed, and control a circuit between the second interface and the battery cell to be closed.

Also in accordance with the disclosure, there is provided an unmanned aerial vehicle (UAV) including a rack, a power system, a battery arranged in a battery compartment of the rack, and a battery management system arranged at the rack and configured to control charging and discharging of a battery cell of the battery. The battery management system includes a first interface configured to charge and discharge the battery cell, a second interface configured to charge the battery cell, and a controller communicatively coupled to the first interface and the second interface. One end of the first interface is configured to be coupled to an external power supply or an unmanned aerial vehicle (UAV), and another end of the first interface is coupled to the battery cell. One end of the second interface is configured to be coupled to the external power supply, and another end of the second interface is coupled to the battery cell. The controller is configured to, in response to detecting that the first interface is electrically coupled to the UAV and the second interface is electrically coupled to the external power supply, control a circuit between the first interface and the battery to be closed, and control a circuit between the second interface and the battery cell to be closed.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples. Other drawings can be conceived by those having ordinary skills in the art on the basis of the disclosed drawings without inventive efforts.

FIG. 1 is a schematic structural diagram of an example battery management system consistent with embodiments of the disclosure.

FIG. 2 is a schematic structural diagram of another example battery management system consistent with embodiments of the disclosure.

FIG. 3 is a schematic structural diagram of another example battery management system consistent with embodiments of the disclosure.

FIG. 4 is a schematic structural diagram of another example battery management system consistent with embodiments of the disclosure.

FIG. 5 is a schematic structural diagram of another example battery management system consistent with embodiments of the disclosure.

FIG. 6 is a schematic structural diagram of an example battery consistent with embodiments of the disclosure.

FIG. 7 is a schematic structural diagram of an example unmanned aerial vehicle (UAV) consistent with embodiments of the disclosure.

FIG. 8 is a schematic structural diagram of another example UAV consistent with embodiments of the disclosure.

### DETAILED DESCRIPTION OF THE EMBODIMENTS

In order to provide a clearer illustration of purposes, technical solutions, and advantages of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

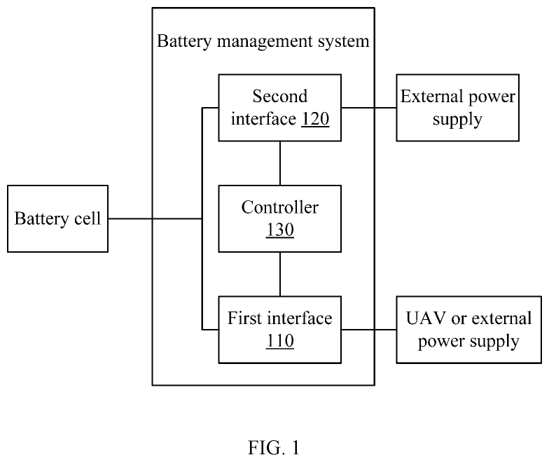

FIG. 1 is a schematic structural diagram of an example battery management system consistent with the disclosure. As shown in FIG. 1, the battery management system includes a first interface 110, a second interface 120, and a controller 130. The controller 130 is communicatively coupled to the first interface 110 and the second interface 120. The first interface 110 can be configured to charge and discharge a battery cell. The first interface 110 can include a charging and discharging interface. The second interface 110 can be configured to charge the battery cell. The second interface 110 can include a charging interface.

One end of the first interface 110 can be coupled to an external power supply or an unmanned aerial vehicle (UAV), and another end of the first interface 110 can be coupled to the battery cell of a battery. When the one end of the first interface 110 is coupled to the external power supply and the another end of the first interface 110 is coupled to the battery cell, the first interface 110 can charge the battery cell. When the one end of the first interface 110 is coupled to the UAV, and the another end of the first interface 110 is coupled to the battery cell, the first interface 110 can discharge the battery cell into the UAV.

One end of the second interface 120 can be coupled to the external power source, and another end of the second interface 120 can be coupled to the battery cell of the battery. When the one end of the second interface 120 is coupled to the external power supply, and the another end of the second interface 120 is coupled to the battery cell, the second interface 120 can charge the battery cell.

The controller 130 can be configured to, when detecting that the first interface 110 is electrically coupled to the UAV and the second interface 120 is electrically coupled to the external power supply, control both a circuit between the first interface 110 and the battery and a circuit between the second interface 120 and the battery cell to be closed.

In some embodiments, the controller 130 can be configured to detect whether the first interface 110 is electrically coupled to the UAV. When the controller 130 detects that the first interface 110 is electrically coupled to the UAV, the battery can discharge to the UAV via the first interface 110. The circuit between the first interface 110 and the battery cell can be controlled to be closed, for example, a discharging circuit between the battery cell and the first interface 110 can be controlled to be closed. In a situation where the circuit between the battery cell and the first interface 110 is closed and the first interface 110 is coupled to the UAV, the battery cell can discharge to the UAV via the first interface 110, such that a discharging function of the first interface 110 can be achieved. The controller 130 can be also configured to detect whether the second interface 120 is electrically coupled to the external power supply. When the controller 130 detects that the second interface 120 is electrically coupled to the external power supply, the battery can be charged via the second interface 120. The circuit between the second interface 120 and the battery cell can be controlled to be closed, for example, a charging circuit between the battery cell and the second interface 120 can be controlled to be closed. In a situation where the circuit between the battery cell and the second interface 120 is closed and the second interface 120 is coupled to the external power source, the battery cell can be charged via the second interface 120, such that a charging function of the second interface 120 can be achieved. Therefore, the battery cell can be charged and discharged simultaneously.

Consistent with the disclosure, when it is detected that the first interface 110 is electrically coupled to the UAV and the second interface 120 is electrically coupled to the external power supply, both the circuit between the first interface and the battery and the circuit between the second interface and the battery cell can be controlled to be closed. As such, the discharging function of the first interface and the charging function of the second interface can be simultaneously realized, thereby allowing the external power supply to supply power to the battery while discharging the battery into the UAV. When the battery is exhausted, there is no need to detach the battery from the UAV, such that a length of time that the battery can continue to supply power to the UAV can be increased. Therefore, an endurance life of the UAV can be extended and a user experience can be improved.

In some embodiments, the controller 130 can be further configured to, when detecting that the first interface 110 is electrically coupled to the UAV, and the second interface 120 is not electrically coupled to the external power supply, control the circuit between the first interface 110 and the battery cell to be closed, and control the circuit between the second interface 120 and the battery cell to be open.

If the first interface 110 is coupled to the UAV, and the second interface 120 is not coupled to any external power supply, the controller 130 can detect that the first interface 110 is electrically coupled to the UAV, and hence the battery can discharge to the UAV via the first interface 110. The circuit between the first interface 110 and the battery cell can be controlled to be closed, for example, the discharging circuit between the battery cell and the first interface 110 can be controlled to be closed. When the circuit between the battery cell and the first interface 110 is closed and the first interface 110 is coupled to the UAV, the battery cell can discharge to the UAV via the first interface 110. The controller 130 can also detect that the second interface 120 is not electrically coupled to the external power supply, and hence the battery cell cannot be charged via the second interface 120. The circuit between the second interface 120 and the battery cell can be controlled to be open, for example, the charging circuit between the battery cell and the second interface 120 can be controlled to be open. When the circuit between the battery cell and the second interface 120 is open, an occurrence of short circuit can be avoided. Therefore, the battery cell can be only discharged at a time.

In some embodiments, the controller 130 can be further configured to, when detecting that the first interface 110 is electrically coupled to the external power supply, control the circuit between the first interface 110 and the battery cell to be closed, and control the circuit between the second interface 120 and the battery cell to be open.

If the first interface 110 is coupled to the external power supply, the controller 130 can detect that the first interface 110 is electrically coupled to the external power supply, and hence the battery can be charged via the first interface 110. The circuit between the first interface 110 and the battery cell can be controlled to be closed, for example, a charging circuit between the battery cell and the first interface 110 can be controlled to be closed. When the circuit between the battery cell and the first interface 110 is closed and the first interface 110 is coupled to the external power supply, the battery cell can be charged via the first interface 110. As such, the charging function of the first interface 110 can be achieved. When the first interface 110 is coupled to the external power supply, regardless of whether the second interface 120 is electrically coupled to the external power supply or not, the battery cell does not need to be charged via the second interface 120. The circuit between the second interface 120 and the battery cell can be controlled to be open, for example, the charging circuit between the battery cell and the second interface 120 can be controlled to be open. When the circuit between the battery cell and the second interface 120 is open, the occurrence of short circuit can be avoided. Therefore, the battery cell can be charged via only the charging and discharging interface (e.g., the first interface 110) at the a time.

In some embodiments, the controller 130 can be further configured to, when detecting that the first interface 110 is not coupled to the external power supply or the UAV, and the second interface 120 is electrically coupled to the external power supply, control the circuit between the second interface 120 and the battery cell to be closed.

If the first interface 110 is not coupled to the external power supply or the UAV, the controller 130 can detect that the first interface 110 is not coupled to the external power supply or the UAV, and hence the battery cell does not need to charge or discharge via the first interface 110. The circuit between the first interface 110 and the battery cell can be controlled to be open or closed. Since the first interface 110 is the charging and discharging interface, the first interface 110 can include a safety connector, and hence there is no risk of the occurrence of short circuit. The controller 130 can also detect that the second interface 120 is coupled to the external power supply, and hence the battery cell can be charged via the second interface 120. The circuit between the second interface 120 and the battery cell can be controlled to be closed, for example, the charging circuit between the battery cell and the second interface 120 can be controlled to be closed. In the situation that the circuit between the battery and the second interface 120 is closed and the second interface 120 is coupled to the external power supply, the battery can be charged via the second interface 120, such that the charging function of the second interface 120 can be realized. Therefore, the battery cell can be charged via only the charging interface (e.g., the second interface 120) at a time.

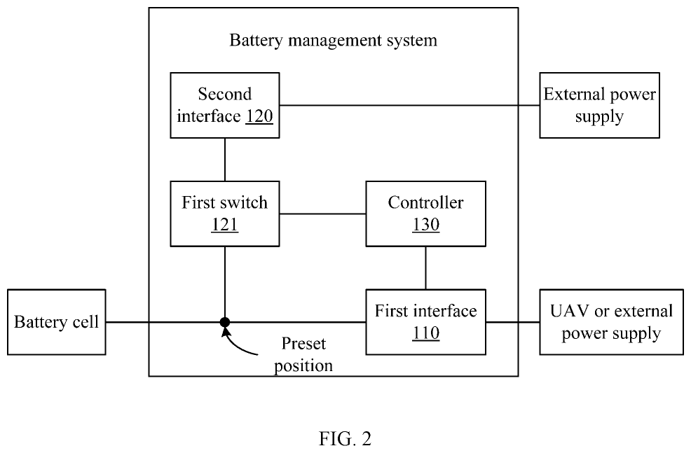

FIG. 2 is a schematic structural diagram of another example battery management system consistent with the disclosure. As shown in FIG. 2, on the basis of the battery management system in FIG. 1, a first switch 121 is arranged between the another end of the second interface 120 and the battery cell. The first switch 121 can be configured to control the circuit between the second interface 120 and the battery cell to be closed or open.

In some embodiments, controlling the circuit between the second interface 120 and the battery cell can be realized by the controller 130 via controlling a closing or opening of the first switch 121. The controller 130 can be configured to control the first switch 121 to be closed, when the circuit between the second interface 120 and the battery cell needs to be closed. The controller 130 can be configured to control the first switch 121 to be opened, when the circuit between the second interface 120 and the battery cell needs to be open.

In some embodiments, two ends of the first switch 121 can be connected to the second interface 120 and a preset position of the circuit between the first interface 110 and the battery cell. That is, the another end of the second interface 120 can connect to the preset position of the circuit between the first interface 110 and the battery cell, when the first switch 121 is closed. As such, when the controller controls the first switch 121, the circuit between the battery cell and the first interface 110 cannot be affected.

In some embodiments, the first switch 121 can include a Metal-Oxide-Semiconductor (MOS) transistor or a solid state relay. In some embodiments, when the first switch 121 includes the MOS transistor, the first switch 121 can include a single MOS transistor, such that the second interface 120 can be exposed outside when the battery cell is not charged via the second interface 120. Therefore, charging of the battery cell can be more convenient, safe and reliable characteristics can be obtained, and the occurrence of short circuit can be avoided. In some embodiments, when the first switch 121 includes the MOS transistor, the first switch 121 can include back-to-back MOS transistors, thereby preventing a back flow of current.

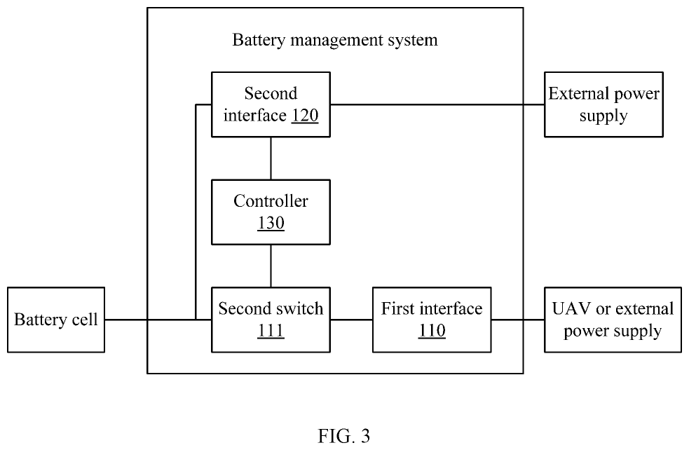

FIG. 3 is a schematic structural diagram of another example battery management system consistent with the disclosure. As shown in FIG. 3, on the basis of the battery management system shown in FIG. 1, a second switch 111 is arranged between the first interface 110 and the battery cell. The second switch 111 can be configured to control the circuit between the first interface 110 and the battery cell to be closed or open.

In some embodiments, controlling the circuit between the first interface 110 and the battery cell can be realized by the controller 130 via controlling a closing or opening of the second switch 111. The controller 130 can be configured to control the second switch 111 to be closed, when the circuit between the first interface 110 and the battery cell needs to be closed. The controller 130 can be configured to control the second switch 111 to be opened when the circuit between the first interface 110 and the battery cell needs to be open. When the second switch 111 is controlled to be opened, the first interface 110 can be controlled to stop charging and discharging the battery to ensure a safety of the battery.

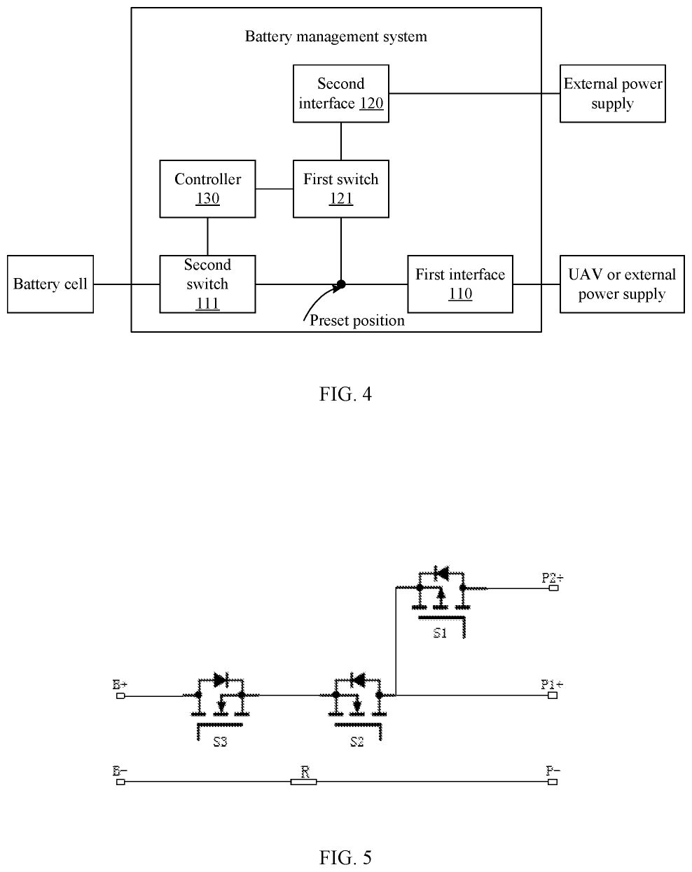

FIG. 4 is a schematic structural diagram of another example battery management system consistent with the disclosure. As shown in FIG. 4, on the basis of the battery management system in FIG. 3, the first switch 121 is arranged between the second interface 120 and the battery cell and is coupled to the second interface 120 and the preset position of the circuit between the first interface 110 and the battery cell, and the second switch 111 is arranged between the battery cell and the first interface 110.

The first switch 121 in FIG. 4 is similar to that in FIG. 3, and detailed description thereof is omitted herein.

When the battery is charged via the first interface 110, the first switch 121 can be controlled to be closed, and the second switch 111 can be controlled to be opened. When the battery is charged via the second interface 120, the first switch 121 can be controlled to be closed, and the second switch 111 can be also controlled to be closed. In this way, the battery can also be discharged via the first interface 110.

In some embodiments, the second switch 111 can include a MOS transistor or a solid state relay. In some embodiments, when the second switch 111 includes the MOS transistor, the second switch 111 can include a single MOS transistor. In some embodiments, when the second switch 111 includes the MOS transistor, the second switch 111 can include back-to-back MOS transistors, thereby preventing the back flow of current. When the second switch 111 includes the back-to-back MOS transistors, the first switch 121 may be a separate MOS transistor.

FIG. 5 is a schematic structural diagram of another example battery management system consistent with the disclosure. As shown in FIG. 5, P1+ is the first interface, P2+ is the second interface, B+ is the battery cell, S1 is the first switch, a combination of S2 and S3 is the second switch, and S2 and S3 are the back-to-back MOS transistors. Thus, the battery management system can include two charging interfaces (e.g., P1+, P2+). The P1+ can have the charging and discharging function, and P2+ can have the charging function. The P2+ can be controlled by a single MOS transistor, such that the P2+ can be exposed outside when the battery cell is not charged via the P2+. Therefore, charging of the battery cell can be more convenient, safe and reliable characteristics can be obtained, and the occurrence of short circuit can be avoided. The specific implementation processes can be as follows. When the battery cell is charged via P1+, S2 and S3 can be turned on, and S1 can be turned off. In this way, P2+ has no voltage and the occurrence of external short circuit can be prevented. When the battery cell is charged via P2+, S1, S2, and S3 can be all turned on. In this way, P1+ can be configured to simultaneously supply power to an external device, such as the UAV. Since the P1+ is the charging and discharging interface, the P1+ generally includes a safety connector, and hence there is no risk of the occurrence of short circuit.

In some embodiments, the second interface 120 can be configured only to charge the battery cell. That is, the second interface 120 cannot discharge the battery, such that the second interface 120 can include a dedicated charging interface. For convenience of use, the second interface 120 can include an exposed metal device, such as an exposed piece of metal.

In some embodiments, the second interface 120 can be further configured to discharge the battery cell. The controller 130 can be further configured to, when detecting that the first interface 110 is electrically coupled to the UAV and the second interface 120 is electrically coupled to the external power supply, control the circuit between the battery cell and the first interface 110 to be open, and control a circuit between the second interface 120 and the first interface 110 to be closed.

When the first interface 110 is coupled to the UAV and the second interface 120 is coupled to the external power supply, the UAV can be powered by the first interface 110, and the second interface 120 can have the discharging function, for example, the external power supply can be discharged via the second interface 120. Therefore, the UAV can be directly powered by the external power supply via the first interface 110 and the second interface 120 without through the battery cell. Therefore, the controller 130 can be configured to control the circuit between the first interface 110 and the battery cell to be open, and hence, the battery cell does not supply power to the UAV via the first interface 110. The controller 130 can be further configured to control the circuit between the second interface 120 and the first interface 110 to be closed, for example, control the circuit between the external power supply and the UAV to be closed. In this way, the external power supply can directly provide power to the UAV. Therefore, the UAV can be directly powered by the external power supply via the first interface 110 and the second interface 120.

In some embodiments, the external power supply can include a power bank, for example, a power bank for the UAV. For a description of the power bank, reference can be made to that of a conventional power bank, and detailed description thereof is omitted herein.

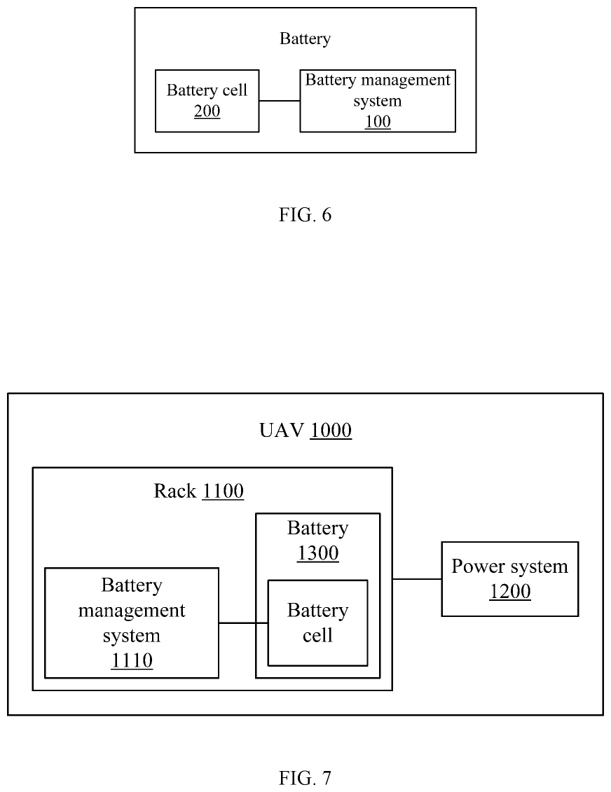

FIG. 6 is a schematic structural diagram of an example battery consistent with disclosure. As shown in FIG. 6, the battery includes a battery management system 100 and a battery cell 200. The battery management system 100 can be configured to control the charging and discharging of the battery cell 200.

The structure, principles, and technical effects of the battery management system 100 are similar to those of the battery management systems in FIGS. 1 to 5, and detailed description thereof is omitted herein.

FIG. 7 is a schematic structural diagram of an example UAV 1000 consistent with the disclosure. As shown in FIG. 7, the UAV 1000 includes a rack 1100, a power system 1200, and a battery 1300. A battery management system 1110 can be arranged at the rack 1100. The battery 1300 can be arranged in a battery compartment of the rack 1100. The battery management system 1110 can be configured to control the charging and discharging of the battery cell of the battery 1300.

The structure, principles, and technical effects of the battery management system 1110 are similar to those of the battery management systems in FIGS. 1 to 5, and detailed description thereof is omitted herein.

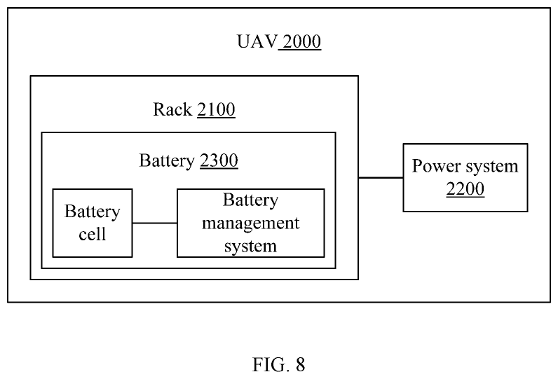

FIG. 8 is a schematic structural diagram of another example UAV 2000 consistent with the disclosure. As shown in FIG. 8, the UAV 2000 includes a rack 2100, a power system 2200, and a battery 2300. The battery 2300 can be arranged in a battery compartment of the rack 2100.

The structure, principles, and technical effects of the battery 2300 are similar to those of the battery in FIG. 6, and detailed description thereof is omitted herein.

The power system can include an electric speed governor, a motor, and a propeller. The electric speed governor can be electrically coupled to a flight controller and a motor in the rack, such that the power system can provide power to the UAV for flight.

Some or all processes of a method consistent with the disclosure can be implemented in a combination of computer software and electronic hardware. The computer program stored in a non-transitory computer-readable storage medium. The computer program can include instructions that enable a computer device, such as a personal computer, a server, or a network device, to perform some or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

It is intended that the embodiments disclosed herein are merely for illustrating the technical solutions of the present disclosure and not to limit the scope of the disclosure. Changes, modifications, alterations, and variations of the above-described embodiments may be made by those skilled in the art without departing from the scope of the disclosure. The scope of the invention can be defined by the following claims or equivalent thereof.

What is claimed is:

1. A battery comprising:
a battery cell; and
a battery management system configured to control charging and discharging of the battery cell, the battery management system including:
a first interface configured to charge and discharge the battery cell, one end of the first interface being configured to be coupled to an external power supply or an unmanned aerial vehicle (UAV), and another end of the first interface being coupled to the battery cell;
a second interface configured to charge the battery cell, one end of the second interface being configured to be coupled to the external power supply, and another end of the second interface being coupled to the battery cell; and
a controller communicatively coupled to the first interface and the second interface and configured to, in response to detecting that the first interface is electrically coupled to the UAV and the second interface is electrically coupled to the external power supply:
control a circuit between the first interface and the battery to be closed, and
control a circuit between the second interface and the battery cell to be closed.

2. The battery of claim 1, wherein:
the battery management system further includes a switch arranged between the another end of the second interface and the battery cell; and
the controller is further configured to control closing or opening of the switch to control the circuit between the second interface and the battery cell to be closed or open.

3. The battery of claim 2, wherein two ends of the switch are connected to the second interface and a preset position of the circuit between the first interface and the battery cell.

4. The battery of claim 2, wherein the switch includes a Metal-Oxide-Semiconductor (MOS) transistor or a solid state relay.

5. The battery of claim 4, wherein the switch includes back-to-back MOS transistors.

6. The battery of claim 1, wherein the controller is further configured to, in response to detecting that the first interface is electrically coupled to the UAV, and the second interface is not electrically coupled to the external power supply:
control the circuit between the first interface and the battery cell to be closed, and
control the circuit between the second interface and the battery cell to be open.

7. The battery of claim 1, wherein the controller is further configured to, in response to detecting that the first interface is electrically coupled to the external power supply:
control the circuit between the first interface and the battery cell to be closed, and
control the circuit between the second interface and the battery cell to be open.

8. The battery of claim 1, wherein the controller is further configured to, in response to detecting that the first interface is not coupled to the external power supply or the UAV and the second interface is electrically coupled to the external power supply:
control the circuit between the second interface and the battery cell to be closed.

9. The battery of claim 1, wherein:
the battery management system further includes a switch arranged between the first interface and the battery cell; and
the controller is further configured to control closing or opening of the second switch to control the circuit between the first interface and the battery cell to be closed or open.

10. The battery of claim 9, wherein:
the battery management system further includes a first switch arranged between the another end of the second interface and the battery cell, two ends of the first switch being connected to the second interface and a preset position of the circuit between the first interface and the battery cell; and
the switch arranged between the first interface and the battery cell is a second switch arranged between the battery cell and the preset position.

11. The battery of claim 9, wherein the switch includes a Metal-Oxide-Semiconductor (MOS) transistor or a solid state relay.

12. The battery of claim 11, wherein the switch includes back-to-back MOS transistors.

13. The battery of claim 1, wherein the second interface is configured to only charge the battery cell.

14. The battery of claim 1, wherein:
the second interface is further configured to discharge the battery cell; and
the controller is further configured to, in response to detecting that the first interface is electrically coupled to the UAV and the second interface is electrically coupled to the external power supply:
control the circuit between the first interface and the battery cell to be open, and
control a circuit between the second interface and the first interface to be closed.

15. An unmanned aerial vehicle (UAV) comprising:
a rack;
a power system;
a battery arranged in a battery compartment of the rack; and
a battery management system arranged at the rack and configured to control charging and discharging of a battery cell of the battery, the battery management system including:
a first interface configured to charge and discharge the battery cell, one end of the first interface being configured to be coupled to an external power supply or an unmanned aerial vehicle (UAV), and another end of the first interface being coupled to the battery cell;
a second interface configured to charge the battery cell, one end of the second interface being configured to be coupled to the external power supply, and another end of the second interface being coupled to the battery cell; and
a controller communicatively coupled to the first interface and the second interface and configured to, in response to detecting that the first interface is electrically coupled to the UAV and the second interface is electrically coupled to the external power supply:
control a circuit between the first interface and the battery to be closed, and
control a circuit between the second interface and the battery cell to be closed.

16. The UAV of claim 15, wherein:
the battery management system further includes a switch arranged between the another end of the second interface and the battery cell; and
the controller is further configured to control closing or opening of the switch to control the circuit between the second interface and the battery cell to be closed or open.

17. The UAV of claim 16, wherein two ends of the switch are connected to the second interface and a preset position of the circuit between the first interface and the battery cell.

18. The UAV of claim 16, wherein the switch includes a Metal-Oxide-Semiconductor (MOS) transistor or a solid state relay.

19. The UAV of claim 18, wherein the switch includes back-to-back MOS transistors.

20. The UAV of claim 15, wherein:
the battery management system further includes a switch arranged between the first interface and the battery cell; and
the controller is further configured to control closing or opening of the second switch to control the circuit between the first interface and the battery cell to be closed or open.
